(19) United States
(12) Patent Application Publication
(10) Pub. No.: US 2006/0115185 A1
(43) Pub. Date: Jun. 1, 2006

(54) Editing condition setting device and program for photo movie

(75) Inventors: Takayuki Iida, Kanagawa (JP); Fumihiro Sonoda, Kanagawa (JP); Hajime Araya, Kanagawa (JP); Kei Yamaji, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/280,272

(22) Filed: Nov. 17, 2005

(30) Foreign Application Priority Data
Nov. 17, 2004 (JP) 2004-333453
Nov. 17, 2004 (JP) 2004-333454

(51) Int. Cl. G06K 9/54; G11B 27/00

(52) U.S. Cl. 382/305; 715/726

(57) ABSTRACT

When a zoom effect or a panning effect is selected for an editing condition of a photo movie, a cutout area for cutting out a still image is set. When a face image of a person is detected in the cutout area designated by a user, the cutout area is automatically adjusted so as to have an optimal margin around the face image based on a position and size of the face image. When the face image is not detected in the cutout area, a position and size of the cutout area is adjusted manually.

### BACKGROUND OF THE INVENTION

1. Field of the Invention

The present invention relates to a device and a program for setting editing conditions for producing a photo movie.

2. Background Arts

A photo movie is a pseudo moving image in which a still image recorded by use of a digital camera or the like is processed and edited for application of special effects which give motion to the still image. The special effects include an electronic zoom effect for zooming in/out a part of the still image, an electronic panning effect for scrolling a closed-up image, a moving effect for moving linearly or curvedly the image displayed in a reduced size, a rotating effect for rotating the image around a specified point, a skew effect for skewing the image, a multiple effect in which these effects are combined, and so forth.

A visual range to the still image is changed apparently by the above special effects (hereinafter referred to as an effect), so that a specified subject can draw attention, and the image can be expressed vividly. In addition, a multi-screen effect for displaying the plural images simultaneously and a visual effect for composing an animation, a decorative image, and a subtitle can be used together. Moreover, the image can be displayed as a slide show without applying these effects.

Softwares for producing the photo movie are described in Japanese Patent Laid-Open Publication No. 10-200843, and “LiFE* with-Photo-Cinema” from Digitalstage, Ltd., URL:http://www.digitalstage.net/jp/product/life/index.html, searched Apr. 6, 2004. In these softwares, the photo movie can be produced by setting the editing condition constituted of a reproduction order and the kind of effects after selecting the still image as a material for the photo movie. The photo movie can be watched on these softwares. Additionally, if the photo movie is converted to a general digital moving format and recorded in an optical disk such as DVD, the photo movie can be watched with home DVD players or the like without using the softwares.

The software described in the above “LiFE* with-Photo-Cinema” is provided with a manual editing mode in which all the editing conditions are set by a user and an automatic editing mode in which the photo movie is produced only by selecting the image as the material. In the automatic editing mode, selection order of the still image becomes the reproduction order, and the kind of effects to be applied to each image is automatically set, so that operation is considerably simplified.

However, in the automatic editing mode, the proper effect based on the contents of image is not set. Therefore, a movie somewhat irrelevant to the subject may be produced when selecting the effect for displaying the image in an enlarged size such as the zoom effect and the panning effect. As a result, there is disadvantage that it is difficult to obtain the picture intended by the user. When the prior manual editing mode is used to prevent such a disadvantage, since the user has to set minutely the position and the size of the image cut out from the entire still image in order to display the image in an enlarged size, a lot of effort is required to display people in the images on the screen in a balanced manner. Also, since the effect is applied to the subject such as scenery and building, there is a problem that great effort is required in the editing work to produce the user's intended image.

### SUMMARY OF THE INVENTION

An object of the present invention is to provide an editing condition setting device and program for a photo movie in which the editing condition of the photo movie required for displaying a subject in a balanced manner can be set easily.

To achieve the above and other objects, an editing condition setting device for a photo movie is provided with a detector for detecting a face image of a subject from a still image and a cutout area determiner for optimizing and determining a position and size of the cutout area so as to ensure a predetermined margin between an outline of the cutout area and the face image based on a position and size of the face image detected by the detector.

According to the preferred embodiment of the present invention, the editing condition setting device includes a target area designator for designating a position of the face image cut out from the still image as a target area through a display screen on which the still image is displayed. The detector detects the face image when the target area is a detected area. The target area designator designates at least one point in the still image to determine an area of a predetermined size centered on the point as the target area, while the cutout area determiner determines the cutout area with reference to the target area.

An editing condition setting program for a photo movie is provided with a detecting function and a cutout area determining function run by a computer. The detecting function detects a face image of a subject from a still image. The cutout area determining function optimizes and determines a position and size of the cutout area so as to ensure a predetermined margin between an outline of the cutout area and the face image based on a position and size of the face image detected by the detecting function.

According to the preferred embodiment of the present invention, the editing condition setting program includes a target area designating function for designating a position of the face image cut out from the still image as a target area through a display screen on which the still image is displayed.

An editing condition setting device for a photo movie is provided with a target area designator, a detector, and a cutout area determiner. The target area designator designates a position of a face image cut out from a still image as a target area through a display screen on which the still image is displayed. The detector detects the face image of a subject from the target area. The cutout area determiner optimizes and determines the position and size of the cutout area so as to ensure a predetermined margin between an outline of the cutout area and the face image based on a position and size of the face image when the face image is detected by the detector, while determines the target area as the cutout area when the face image is not detected by the detector.

According to the preferred embodiment of the present invention, the target area designator designates at least one arbitrary point in the still image to determine an area of a predetermined size centered on the point as the target area, while the cutout area determiner determines the cutout area with reference to the target area.

An editing condition setting program for a photo movie is provided with a target area designating function, a detecting function, and a cutout area determining function run by a computer. The target area designating function designates a position of a cutout object cut out from a still image as a target area through a display screen of a display on which the still image is displayed. The detecting function detects the face image of a subject from the target area. The cutout area determining function optimizes and determines a position and size of the cutout area so as to ensure a predetermined margin between an outline of the cutout area and the face image based on a position and size of the face image when the face image is detected by the detecting function, while determines the target area as the cutout area when the face image is not detected by the detecting function.

According to the present invention, when the editing condition for effects, such as a panning effect and a zoom effect for displaying the image in an enlarged size, required for setting the cutout area is set, the cutout area is automatically determined based on at least one of the position and the size of the face image after the face image is detected in the still image. Thereby, it is possible to easily set the editing condition for arranging the face images of the persons in a display screen in a balanced manner. In addition, unlike the prior art in which a user sets all the editing condition, it is possible to prevent the deterioration in quality of the photo movie caused by poor resolution display of an enlarged image, whose magnification gets too large because of improper setting of the cutout area.

The face image is detected from the cutout area after the cutout area is designated in the still image on the display screen, so that the time required for detecting the face image can be reduced in comparison with the case wherein the face image is detected from the entire still image.

When the cutout area is designated by a user, any one point on the still image is designated as a base point, and the cutout area having a predetermined size is designated around the base point. Thereby, the cutout area can be designated easily.

The deterioration in quality of the photo movie caused by the poor resolution display of enlarged images can be prevented by correcting the image quality of the still image after detecting the face image.

Since the image quality of all the still images read from a recording medium is corrected, the detection accuracy of the face image can be enhanced, and in addition, the quality of the photo movie can be approximately known at the time of setting the editing condition.

Additionally, according to the present invention, when the editing condition is set for the effect that requires the setting of the cutout area, the judge is made on whether the face image detected in the still image is also present in the cutout area designated by the user. When it is determined that the face image is present, the cutout area is adjusted based on at least one of the position and the size of the face image. Thereby, the cutout area are optimized to spotlight the person can be set easily, so that it is possible to obtain the photo movie in which the faces of the persons are arranged in the screen in a balanced manner. In addition, the cutout area can also be optimized to spotlight a landscape or the back ground of the person, and it is possible to obtain the photo movie in which the intention of the client is much reflected.

Since the cutout area in which a pixel number is smaller than a predetermined reference value is not designated, the magnification for enlarging the image in the cutout area does not become large excessively, and it is possible to prevent the quality of the photo movie from degrading due to the poor resolution display of images.

Since the adjustment to the cutout area is selectively activated, it is possible to set the cutout area to provide a well-balanced arrangement of the person and the back ground even if the face image is detected in the cutout area. Therefore, it is possible to obtain the photo movie in which the intention of the client is much reflected.

### BRIEF DESCRIPTION OF THE DRAWINGS

The above objects and advantages of the present invention will become apparent from the following detailed descriptions of the preferred embodiments when read in association with the accompanying drawings, which are given by way of illustration only and thus do not limit the present invention. In the drawings, the same reference numerals designate like or corresponding parts throughout the several views, and wherein:

FIG. 1 is a schematic view showing a constitution of an order receiving system for a photo movie of the present invention;

FIG. 2 is a flow chart showing processing procedure of an order receiving apparatus;

FIG. 3 is a flow chart showing processing procedure for setting a cutout area;

FIGS. 4A and 4B are explanatory views showing a state of a screen at the time of setting a start point of a panning effect;

FIGS. 5A and 5B are explanatory views showing a state of the screen at the time of setting an end point of the panning effect;

FIGS. 6A, 6B, and 6C are explanatory views showing transition of the images of the photo movie;

FIG. 7 is a flow chart showing processing procedure for setting the cutout area;

FIGS. 8A and 8B are explanatory views showing a state of the screen at the time of setting the start point of the panning effect;

FIGS. 9A and 9B are explanatory views showing a state of the screen at the time of setting the end point of the panning effect;

FIGS. 10A and 10B are explanatory views showing a state of the screen at the time of setting a transferring point of the panning effect; and

FIGS. 11A, 11B, 11C, 11D, and 11E are explanatory views showing transition of the images of the photo movie.

### DETAILED DESCRIPTION OF THE EMBODIMENTS

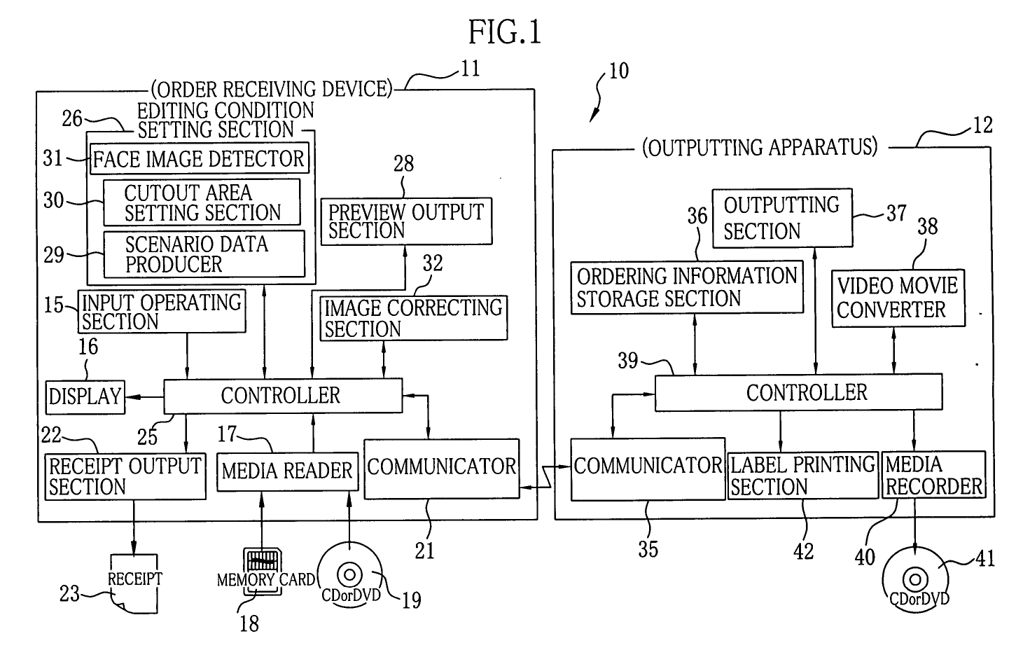

In FIG. 1, an order receiving system 10 for a photo movie is constituted of an order receiving apparatus 11 and an outputting apparatus 12. The order receiving apparatus 11 and the outputting apparatus 12 are set at the same shop such as a DPE shop and communicably connected to each other through a local area network (LAN). The order receiving apparatus 11 may be set at a remote place from the outputting apparatus 12. In this case, they may be connected communicably through the internet.

The order receiving apparatus 11 is provided with an input operating section 15 and a display 16. An order is input as ordering information by operating the input operating section 15, and then displayed on the display 16. The input operating section 15 is constituted of a touch panel formed integrally with a display screen of the display 16. The input processing is executed by touching a position of a selection key displayed on the screen. A media reader 17 reads image data from a memory card 18 and an optical disk 19 such as CD or DVD, brought by a client. The memory card 18 is detachable on a digital camera and used for storing taken images. The optical disk 19 is a large-capacity storage medium capable of storing more taken images than the memory card 18. The image data stored in a personal computer or the like is copied into the optical disk 19.

A communicator 21 sends and receives data between the order receiving apparatus 11 and the outputting apparatus 12. A receipt output section 22 issues a receipt 23 as a certificate for receiving the product. Identification information for discerning the order is printed on the receipt 23. The identification information includes an order number, an identification code of the order receiving apparatus 11, a delivery date and shop of the product, and these are recorded in bar-codes and characters.

A controller 25 and an editing condition setting section 26 are established when a microprocessor is actuated to execute both an operating system stored in a storage device (not shown) in the order receiving apparatus 11 and an editing condition setting program for setting the editing condition of the photo movie. The storage device is constituted of a hard disk memory device (HDD) or a memory unit having a large number of memory chips, for example. The controller 25 controls each hardware including the media reader 17 and the communicator 21, and manages the operation of each hardware in response to the operation on the input operating section 15.

The editing condition such as whether to use effects and the kind of effects for each still image used in the photo movie is set by the input operation on the editing condition setting section 26. The editing condition setting section 26 has an automatic editing mode in which the effects for all the still images are automatically determined in accordance with a prepared scenario template and a manual editing mode in which the effect is manually set for each image. The plural kinds of scenario templates are prepared for each theme such as seasons and annual events. There are templates for traveling, wedding, commencement, New Year's holidays, star festival, Christmas, and so forth. The kind of decorative image to be composed in the taken image and the effect to be selected are different in each template.

A preview output section 28 outputs a preview of the photo movie based on the editing condition set by the editing condition setting section 26. The preview has the same effects as a finished photo movie is going to have. The preview output section 28 produces low-resolution versions of the read out image, which has less pixel numbers than the taken images have in the memory card 18 or the optical disk 19, and then produces the preview from the low-resolution images. Owing to the low-resolution images, the load on the microprocessor is reduced when producing and displaying the preview. The preview is displayed on the display 16 to show the user the quality of the photo movie in finishing.

The editing condition setting section 26 is constituted of a scenario data producer 29, a cutout area setting section 30, and a face image detector 31. The scenario data producer 29 produces the scenario data incorporating the editing condition in which a reproducing order of the images, whether to use the effects, and the kind of the effect in each image are designated. The scenario data is constituted by associating the kind and the detailed setting contents of the effect with a file name of the image data. The scenario data is sent to the outputting apparatus 12 as a part of the ordering information, along with the image data of the still image.

The cutout area setting section 30 cuts out a part of the still image to establish it as a cutout area to which the special effect is applied. The cutout area is a parameter of the effects to spotlight a subject in the still image. Such effects include a zoom effect for zooming in/out a part of the still image, a panning effect for scrolling the closed-up image, and a spot-light effect for casting a spot light on the still image by displaying the still image in black except for the part.

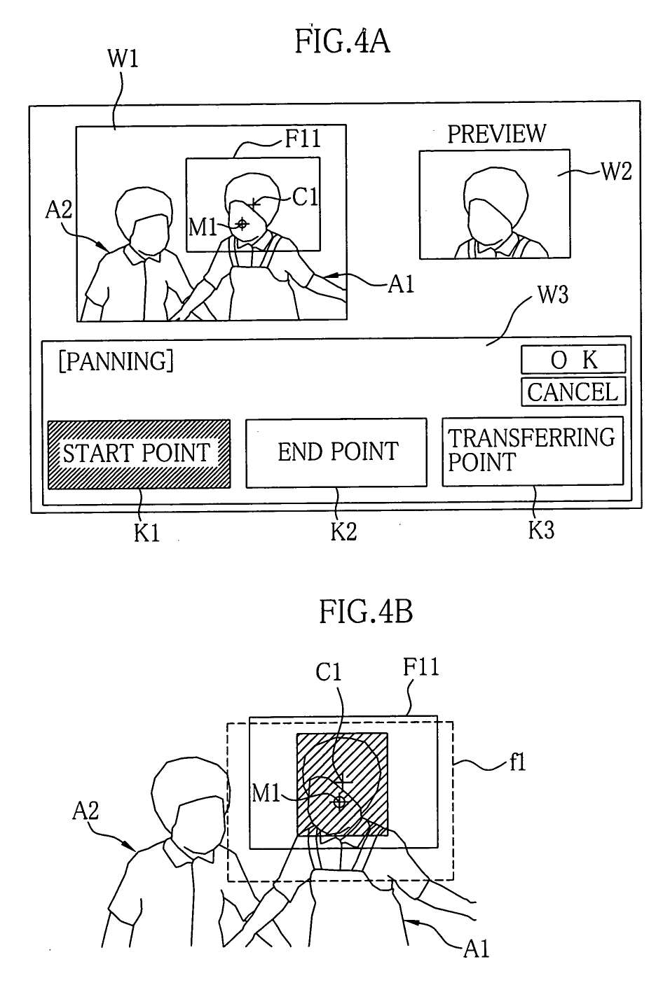

In the zoom effect, the entire still image is firstly displayed at a reduced or unchanged magnification, and then changed in magnification to a range determined with the cutout area. Namely, the cutout area determines a display range at the end of zooming in or at the start of zooming out. In the panning effect, a range of the image to be closed up at the start and end of the panning is determined. In the spot-light effect, the area displayed clearly is determined. In the zoom effect and the panning effect, the cutout area of a rectangular shape, in which aspect ratio is fixed based on the aspect ratio of the screen of the display for reproducing and displaying the photo movie, is set. In the spot-light effect and other effects, the shape of the cutout area can have other shape such as a round shape. Note that one cutout area is set in the zoom effect, while the plural cutout areas are set in the panning effect. The cutout area is displayed on the screen of the display 16 as a cutout frame F11 (see FIGS. 4A and 4B).

A face image detector 31 detects the face image of the person in the cutout area set by the cutout area setting section 30. In the detection of the face image, a skin is discriminated based on color information of each pixel in the still image, and in addition the face image is discriminated based on the presence of eye, eyebrow, and hair. A shape of the face is specified by discriminating contours of the face and head based on an arrangement pattern of skin color pixels showing a skin of the face and black pixels showing the eye, eyebrow, and hair and brightness difference between the face image and the back ground.

Recommended margin data is stored in the cutout area setting section 30. The recommended margin data designates the optimal margins around the face image in up, down, left, and right directions such that the face image detected by the face image detector 31 is displayed in a balanced manner. Since the optimal margin will vary depending on the compositions of taken images, various recommended margin data is prepared for both the horizontally long images and vertically long images. The recommended margin data is classified in accordance with the number of the detected face images (the number of people), the position of each face, and the ratio of the face image to the entire still image.

An image correcting section 32 applies image correction processing such as a color tone correction to the image data. The image correction processing includes a set-up correction processing and a quality improving processing. The set-up correction processing is applied to all the image data read by the media reader 17, and the basic image correction processing including gray-balance adjustment, color tone adjustment for adjusting the skin color pixel, and contrast adjustment is applied to all the images. Similarly to the zoom effect and the panning effect, the high-quality processing is applied to the still image including the face image when the face image is detected by the face image detector 31. Specifically, the image correction processing for enhancing the quality of the image, such as correction for distortion caused by lens performance in taking and limb darkening, noise reducing processing, sharpness processing, and shaggy reducing processing is applied.

The outputting apparatus 12 is provided with a communicator 35, an ordering information storage section 36, an outputting section 37, and a video movie converter 38. The ordering information from the order receiving apparatus 11 is received by the communicator 35 to be stored in the ordering information storage section 36. The outputting section 37 analyzes the scenario data incorporated in the ordering information to output the photo movie based on the image data from the order receiving apparatus 11. The video movie converter 38 converts the images of the photo movie into the images conforming to a general digital video format. Note that MPEG2-DVD-Video format is applied as one of the digital video format such that the photo movie can be watched as a DVD picture.

The controller 39 manages the sequence from the processing of the ordering information to the finish of the product by controlling each section based on a pre-installed order processing program. A media recorder 40 records the data of the photo movie in an optical disc 41 such as CD and DVD. A label printing section 42 prints the identification information for discerning the ordering information and a label picture showing the contents of the photo movie on a surface of the optical disk 41.

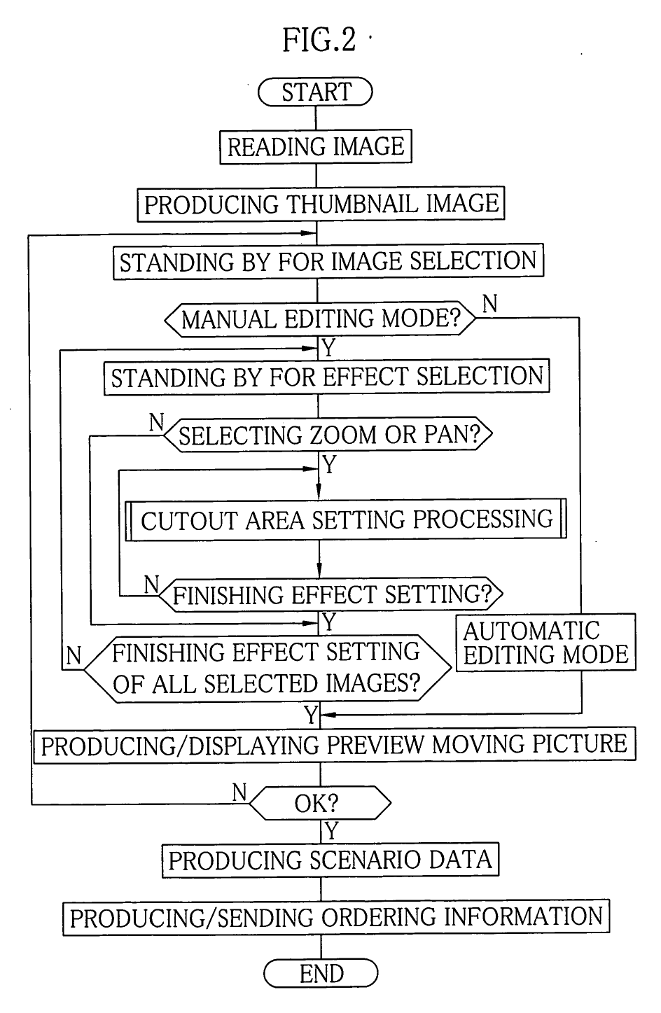

Next, the photo movie order receiving system 10 is explained. In FIG. 2, when the recording medium: the memory card 18 or the optical disk 19 in which the image data of the still image is stored is set in the media reader 17 of the order receiving apparatus 11, the controller 39 detects the recording medium, and then the image data is started to be read in the recording medium.

When the image data is copied from the recording medium, the set-up correction processing is applied to all the image data by the image correcting section 32 to produce thumbnail images from the image data. The thumbnail images are displayed as a list on the display 16. The images used as material for the photo movie are selected by referring to the thumbnail images, and in addition, the operation for selecting all the images can be performed.

The automatic editing mode or the manual editing mode is selected after selecting the images. In the automatic editing mode, the photo movie is automatically produced by using the selected image. In the manual editing mode, the user selects the reproducing order and the kind of effects. When the automatic editing mode is selected, the reproducing order is determined in accordance with the arrangement order of the thumbnail images by the editing condition setting section 26, and then whether to use effects and the kind of effect is determined for each image. At this time, the scenario template prepared for each theme such as seasons and annual events can be selected.

In the manual editing mode, the user sets in detail the editing condition including the reproducing order of the images, whether to use effects in each image, the kind of effects, and the way to apply the effects. The arrangement order of the thumbnail images displayed on the display 16 is changed on the screen of the display 16 through the input operating section 15, so that the reproducing order of the image can be determined. When designating to apply an effect to a certain image, the manual editing mode moves to the step of setting the detail of the effect.

There are many kinds of effects, such as the zoom effect, the panning effect, the spot-light effect, a move effect, a fade-in effect, a composite effect, and a multiple effect in which those effects are combined. In the spot-light effect, the still image is displayed in black except for a part. In the move effect, the still image is displayed in a reduced size on the screen to be moved linearly or curvedly from one end of the screen to the other end. In the fade-in effect, the still image displayed on the screen is gradually transparentized, and the next image gradually appears. In the composite effect, the decorative image and the subtitle are combined.

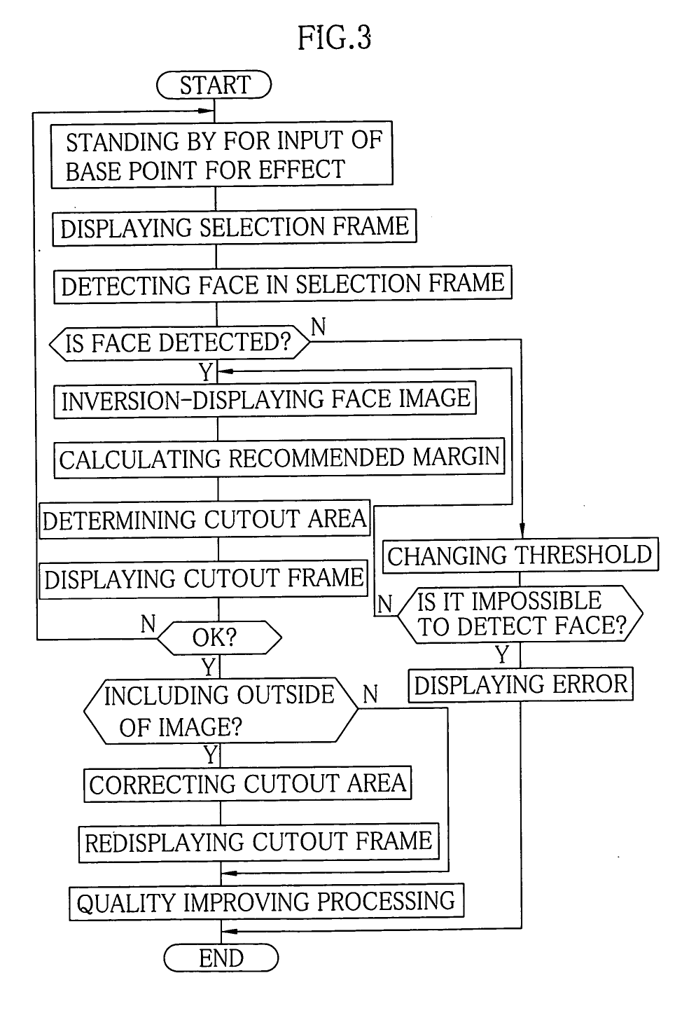

The following is an example of using the panning effect. In FIGS. 3 and 4, when the panning effect is selected, base points of the panning have to be designated first. At least two cutout areas, one including a start point of the panning and the other including an end point, are designated as the base points. According to need, transferring points can be designated between the start point and the end point. As shown in FIG. 4A, an editing window W1, a preview window W2, and a setting window W3 are displayed on the screen of the display 16. The still image in which the effect is designated is displayed in the editing window W1. The image in the cutout area is displayed in the preview window W2. The detailed editing setting is performed on the setting window W3. To designate a base point of the panning, the face of the person is designated on the editing window W1.

As a target image for the panning effect, an image including subjects A1 and A2 is displayed in the editing window W1. Setting keys K1, K2, and K3 for designating respectively the start points, the end point, and the transferring point of the panning are displayed in the setting window W3. When the setting key K1 is operated to designate the start point of the panning, a message directing to designate a point on the editing window W1 is displayed on the screen of the display 16.

The user designates the face of the subject A1, for example, as the start point of the panning. As shown in FIG. 4B, a mark M1 as the designated coordinate and a rectangular selection frame f1 of a constant size centered on the mark M1 are displayed in the editing window W1. The size and the shape of the selection frame f1 may be changed by the input operation.

The face image detector 31 performs the face detecting processing in the selection frame f1. When the face of the person is detected in the selection frame f1, the outline of the face is recognized a recognition range of the face image is displayed in a reversal state based on the outline. When the face is not detected, the face detecting processing is performed again after threshold value for the face detection is lowered. When the face cannot be detected even if the face detecting processing is performed twice, an error message is displayed and the step returns for designating the start point of the panning.

When the face of the subject A1 is detected in the selection frame f1, the number of the person in the selection frame f1 is identified as one. The cutout area setting section 30 refers the recommended margin data based on the position and the size of the face of the subject A1 and calculates the position and the size of the optimal cutout area. The optimized cutout area is displayed as a cutout frame F11. The center of the cutout frame F11 is the same as a center C1 of the recognition range of the face. The image in the cutout frame F11 is displayed in the preview window W2.

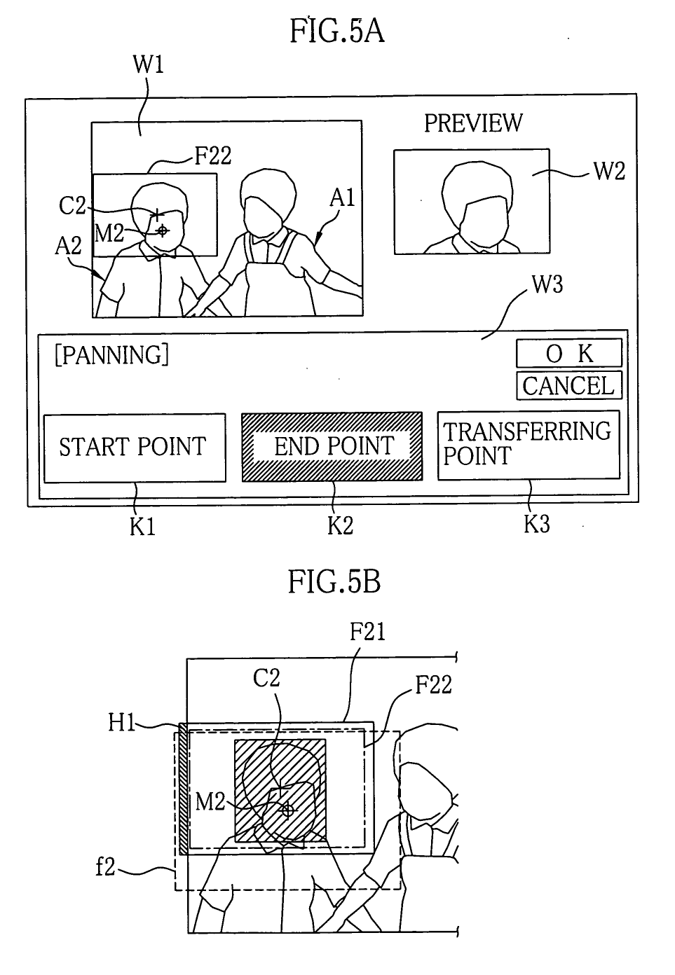

The setting key K2 is operated to proceed to the step of designating the end point of the panning. As shown in FIG. 5A, the user designates the face of the subject A2, for example, as the end point of the panning on the editing window W1. A mark M2 as the designated coordinate and a rectangular selection frame f2 centered on the mark M2 as the cutout area are displayed in the editing window W1.

The face image detector 31 detects the face image of the subject A2 in the selection frame f2. The outline of the subject A2 is recognized, so that the recognition range of the face is displayed in a reversal state, and in addition the number of the person in the selection frame f2 is identified as one. The cutout area setting section 30 refers the recommended margin data based on the position and the size of the face of the subject A2, and calculates the position and the size of the optimal cutout area. The optimized cutout area is displayed as a cutout frame F21. The center of the cutout frame F21 is the same as a center C2 of the recognition range of the face of the subject A2.

The cutout frame F21 includes an external area H1 of the image hatched with diagonal lines in FIG. 5B. Therefore, the external area H1 shows up as a black belt portion in the image in which the subject A2 is closed up. The cutout area setting section 30 reduces the size of the cutout frame F21 with keeping the center C2 to exclude the external area H1. Such a cutout area is displayed as a cutout frame F22. The image in the cutout frame F22 is displayed in the preview window W2.

When the start point and the end point are determined as the cutout frames F11, F22 and the detailed setting of the panning effect is completed, the image correcting section 32 applies the quality improving processing to the image in which the panning effect is designated. Due to the high-quality processing, it is possible to prevent the image quality from lowering at the time of enlarging the faces of the subjects A1 and A2 on the display, and to prevent the quality of the photo movie from deteriorating.

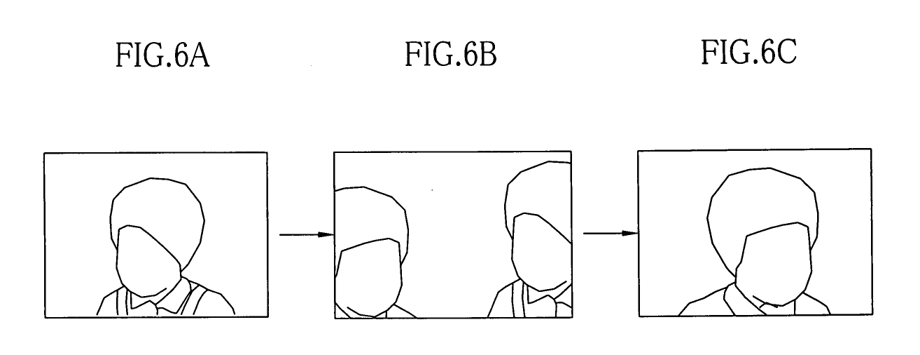

The image of the photo movie in which the base points of the panning effect are set is started from the image in which the face of the subject A1 is closed up in FIG. 6A. Subsequently, a pseudo panning is reproduced by moving the screen from the subject A1 to the subject A2 in FIG. 6B. Thereafter, the image of the photo movie is transferred to the image in which the face of the subject A2 is closed up in FIG. 6C, and one scene of the photo movie is finished. In the panning effect, since the image in the cutout frame F11 is displayed in an enlarged size on the whole screen, enlargement magnification becomes large when the cutout frame F11 is small, while it becomes small when the cutout frame F11 is large. Since at least two cutout areas including the start point and the end point of panning are designated, the enlargement magnification is changed during the panning when the size of the cutout frames F11 and F22 is different from each other.

In FIG. 2, when all the editing condition is entered after the setting of whether to use effects and the kind of effects for other images, the preview of the photo movie is produced by the preview output section 28. The preview is displayed on the display 16 to be confirmed by the client. If it is unnecessary to change the editing condition, the operation for moving to the next step is performed, and then personal information including the name and address is input. The scenario data in which all the editing conditions are recorded is produced in the scenario data producer 29 after the input operation. The controller 25 produces the ordering information including the scenario data, the image data, the personal information of the user, the identification information for discerning the ordering information, and sends the ordering information to the outputting apparatus 12 through the communicator 21. When the receipt output section 22 operated by the controller 39 issues the receipt 23 on which the identification information of the order details is recorded, the order receiving processing is finished.

In the outputting apparatus 12 in which the ordering information is received, the photo movie is produced based on the scenario data and the image data incorporated in the ordering information. The photo movie is converted into image data such as MPEG2-DVD-Video format capable of being watched as the DVD picture based on the order. The image data is recorded in the optical disk 41 such as DVD by the media recorder 40. The optical disk 41 in which the photo movie is recorded is delivered to the customer in exchange for the receipt 23.

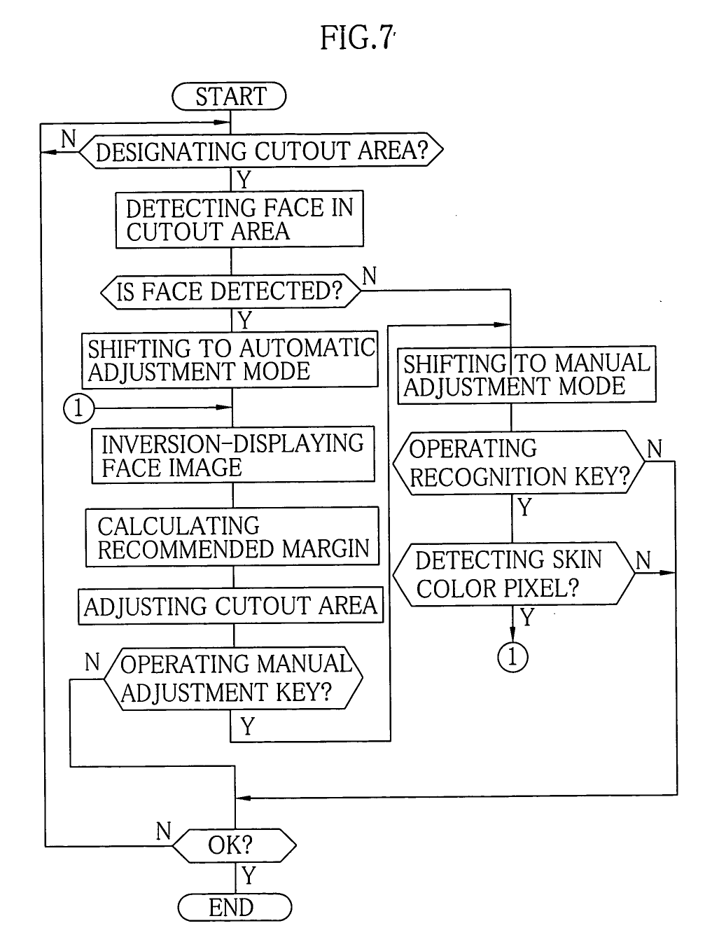

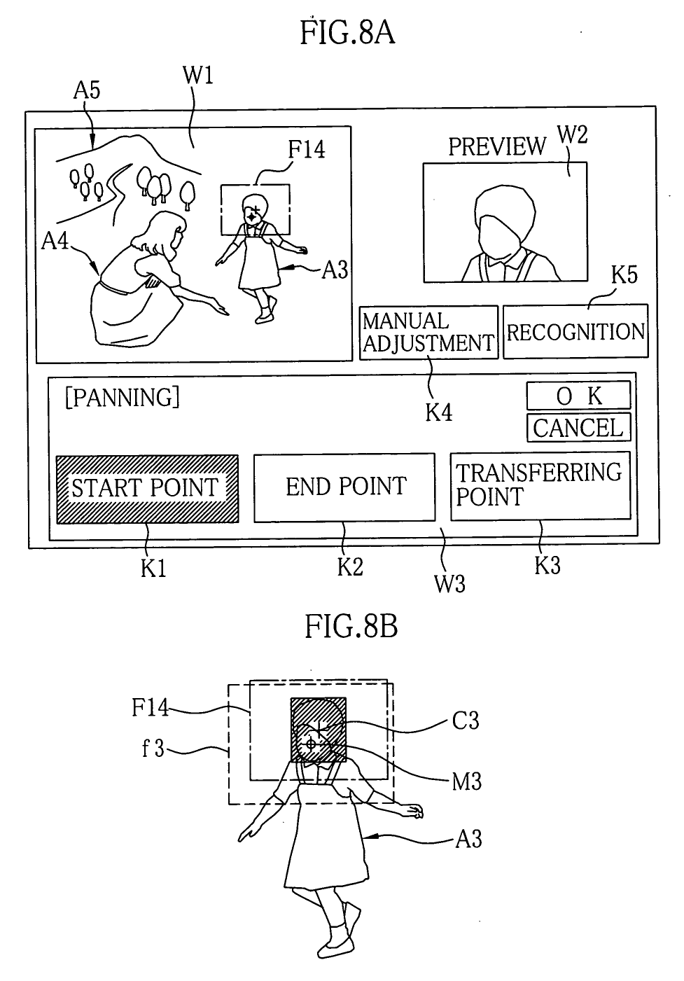

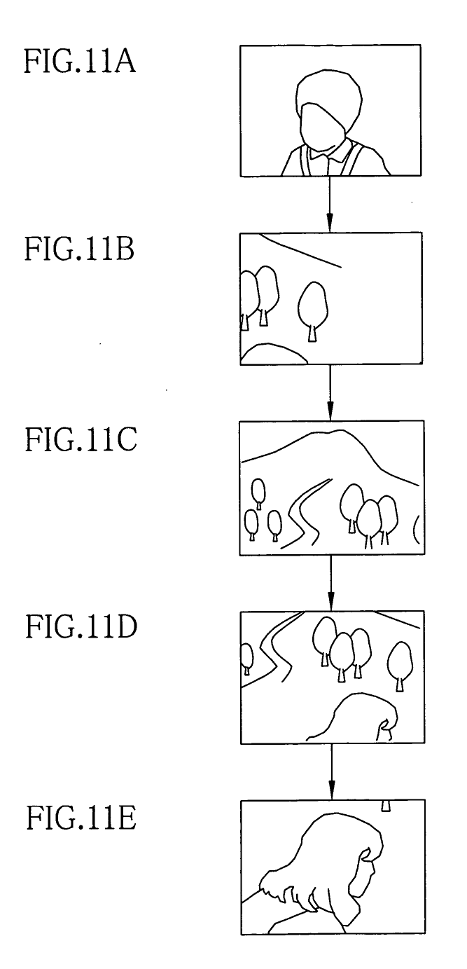

Next, in FIGS. 7-10, the case wherein the cutout area setting section 30 has an automatic adjustment mode and a manual adjustment mode of the cutout area is explained. Moreover, in FIGS. 8-11, the case wherein the subject except for the person is the target subject in the panning is explained. The components same as those in FIGS. 4 and 5 are represented by same numbers. In the automatic adjustment mode, the position and the size of the cutout area is adjusted based on characteristic information of the face image detected by the face image detecting section 31. In the manual adjustment mode, the position and the size of the cutout area is adjusted by the input operation by the user. The automatic adjustment mode is selected when the face image exists in the cutout area, while the manual adjustment mode is selected when the face image does not exist.

The predetermined input operation is performed, so that it is possible to shift forcibly from the automatic adjustment mode to the manual adjustment mode. In this case, after detecting the face image from the cutout area, according to the suitability of the adjusted cutout area, the user can change the cutout area freely by hand. In the manual adjustment mode, the minimum size of the cutout area designated by the user is restricted, and a lower limit of the pixel number in the cutout area is determined as a reference value. Thereby, it is possible to prevent the cutout area which is excessively small in size from being designated.

In FIGS. 7 and 8, the panning effect is selected to move to the step of designating the base points of the panning. In FIG. 8, as the target image for the panning effect, the image including human subjects A3 and A4 and a landscape subject A5 is displayed in the editing window W1. A manual adjustment key K4 and a recognition key K5 in addition to the setting keys K1, K2, and K3 are displayed in the setting window W3. The manual adjustment key K4 forcibly shifts the automatic adjustment mode to the manual adjustment mode. The recognition key K5 makes the face image detector 31 recognize the face image which is not detected by the face image detector 31.

When the start point of the panning is designated, if the user desires to close up the face of the subject A3, the position of the face of the subject A3 is designated. As shown in FIG. 8B, a mark M3 as the designated coordinate and a selection frame f3 as a rectangular cutout area with a predetermined size centered on the mark M3 are displayed in the editing window W1. Although the size and the shape of the selection frame f3 are determined by the initial setting, it can be changed.

The detecting processing of the face image in the selection frame f3 is performed by the face image detector 31 to detect the face image of the subject A3. The face outline of the subject A3 is recognized to display the recognition range of the face image in a reversal state based on the outline. The number of the people included in the selection frame f3 is identified as one from the number of the detected face image. The cutout area setting section 30 refers the recommended margin data based on the position and the size of the subject A3 and calculates the position and the size of the optimal cutout area. The optimized cutout area is displayed as a cutout frame F14. A center of the cutout frame F14 is the same as a center C3 of the recognition range of the face. The image in the cutout frame F14 is displayed in the preview window W2.

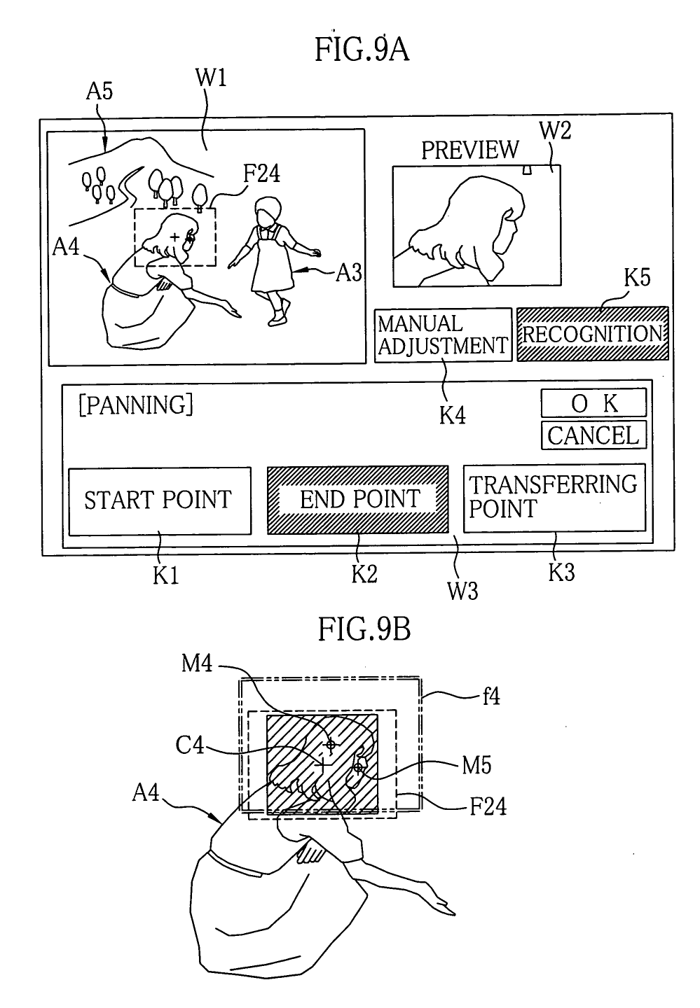

Next, the end point of the panning is set. In FIG. 9A, when the user desires to close up the face of the subject A4, the position of the face of the subject A4 is designated. As shown in FIG. 9B, a mark M4 as the designated coordinate and a selection frame f4 as a rectangular cutout area with a predetermined size centered on the mark M4 are displayed in the editing window W1. The face image detector 31 executes the detecting processing of the face image in the selection frame f4. However, since the subject A4 faces sideways, the feature of the face is not enough, so that the face image of the subject A4 cannot be detected. Accordingly, the cutout area setting section 30 judges that the face image does not exist in the selection frame f4 and displays the selection frame f4 by double lines. At this time, the recognition key K5 blinks, and then a message directing to re-detect the face image is displayed. Due to the selection frame f4 shown by the double lines and the blink of the recognition key K5, the user can understand that the detection of the face image has been failed.

The recognition key K5 is operated to re-detect the face image, and then the message directing to designate the position of the face is displayed. The user designates the position of the face of the subject A4 according to the message. The coordinate designated by the user is displayed as a mark M5. The face image detector 31 detects the skin color pixels distributing around M5, and identifies a region where the skin color pixels aggregate as the face to specify the outline of the face and the head. Thereby, the face image of the subject A4 is forcibly recognized, and then the region estimated as the face image is displayed in the reversal state. The cutout area setting section 30 refers the recommended margin data based on the position and the size of the face of the subject A4 and calculates the position and the size of the optimal cutout area. The optimized cutout area is displayed as a cutout frame F24. The center of the cutout frame F24 is the same as a center C4 of the recognition range of the face. The image in the cutout frame F24 is displayed in the preview window W2.

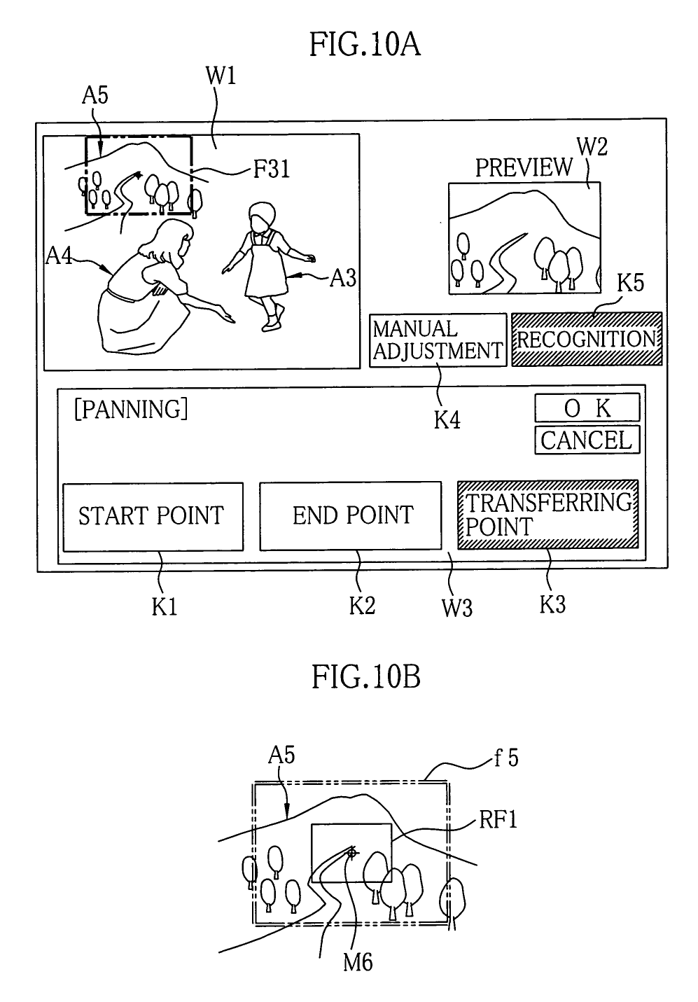

In FIGS. 10A and 10B, when the operation for designating a coordinate on the landscape subject A5 as the transferring point of the panning is performed, a mark M6 as the coordinate and a selection frame f5 are displayed. Although the face image detector 31 performs the detecting processing of the face image in the cutout area defined by the selection frame f5, there is no feature of the face in the subject A5 that is the back ground, so that the face image cannot be detected. The cutout area setting section 30 displays the selection frame f5 with double lines. At this time, the manual adjustment key K4 blinks to inform that the manual adjustment mode is selected. Then the recognition key K5 blinks, and a message directing to re-detect the face image is displayed. Even if the recognition key K5 is operated to specify the coordinates of the subject A5, the face image cannot be detected, and the selection frame f5 is kept displayed with the double lines.

A restriction frame RF1 for restricting the size of the selection frame f5 is displayed in the selection frame f5. Although the position and the size of the selection frame f5 can be changed by the operation on the screen, the size cannot be smaller than the restriction frame RF1. The restriction frame RF1 prevents the deterioration of the image quality caused by displaying the image in the selection frame f5 in an enlarged size at an excessive large magnification. The selection frame f5 in which the position and size are adjusted manually is determined as a cutout frame F31.

In this way, the start point, the end point, and the transferring point of the panning are respectively determined by the cutout frames F14, 24, and 31, and when the detailed setting of the panning effect is finished, the image correcting section 32 applies the quality improving processing to the image in which the panning effect is designated. The quality improving processing prevents the deterioration of the image quality occurring at displaying the subjects A3, A4, and A5 in an enlarged size, and in addition prevents the quality of the photo movie from being lowered. In the set-up correction processing and the quality improving processing, since the proper image quality correction is performed to the human subject, color tone correction may be preformed to the subject except for the human such as the subject A5 when the cutout area is set.

In the present embodiment, although the setting of the editing condition and the production of the photo movie are performed separately by the order receiving apparatus 11 and the outputting apparatus 12, they may be performed by one apparatus. Additionally, application program having equivalent function to the order receiving apparatus 11 is distributed and installed onto a personal computer of a customer, so that the setting of the editing condition and the order of the photo movie may be performed in a home of the customer through communication means such as Internet.

When the plural face images are detected in the still image by the face image detector 31, it is preferable to enable a repeat of the step of designating a face image for a cutout area so that any of or all the detected face images can be designated. Even if the plural still images in various taken scenes are used as material for the photo movie, the editing condition of the photo movie is preferably set by a simple operation.

In the above embodiment, although the input operating section 15 is constituted by the touch panel formed integrally with the screen of the display 16, it may be constituted by other input device such as a pointing device. To define an initial cutout area to be displayed as a selection frame, such as f1-f5, it may be defined by designating two points as the coordinates for two vertices on a diagonal line of a rectangular frame instead of designating one point in the still image. In addition, the cutout area is designated by the user after the face image is detected from the entire image, so that more optimal cutout area may be determined, instead of detecting the face image after the cutout area is designated by the user. In this case, when only one face image is detected in the still image, the cutout area is automatically optimized and determined. Then, an effect which requires one cutout area, such as the zoom effect, is displayed as an available effect for the image, and any effect which requires plural cutout areas, such as the panning effect, may be previously excluded. In addition, it will become easy to judge whether the operation of the recognition key K5 is required because the presence of undetected face images, if any, is previously acknowledged.

The data of the photo movie is not necessarily recorded with the video movie format, but recorded with a format readable on a computer with a specific viewer soft of the photo movie, and in this case viewer soft is distributed to the user. The still image as material for the photo movie may be an image of a printed photograph and a photo film obtained by use of a scanner, or may be a frame of image extracted from a moving picture captured with a video camera or the like, in addition to the image captured with a digital camera.

Although the present invention has been described with respect to the preferred embodiment, the present invention is not to be limited to the above embodiment but, on the contrary, various modifications will be possible to those skilled in the art without departing from the scope of claims appended hereto.

What is claimed is:

1. An editing condition setting device for a photo movie formed by applying processing and editing to a still image, for setting a cutout area including a face image of a subject as editing condition of said photo movie when said face image is cut out from said still image, said editing condition setting device comprising:
a detector for detecting said face image in said still image; and
a cutout area determiner for optimizing and determining a position and size of said cutout area so as to ensure a predetermined margin between an outline of said cutout area and said face image based on a position and size of said face image detected by said detector.

2. An editing condition setting device as claimed in claim 1, further comprising: a target area designator for displaying said still image on a display screen and for enabling to designate a position of said face image to be cut out from said still image as a target area through said display screen wherein said detector detects said face image within said target area.

3. An editing condition setting device as claimed in claim 2, wherein said target area designator enables to designate at least one point in said still image to define an area with a predetermined size centered on said point as said target area, said cutout area determiner determines said cutout area based on said target area.

4. An editing condition setting device as claimed in claim 1, wherein said detector detects said face image within the entire still image.

5. An editing condition setting device as claimed in claim 1, further comprising: an image quality corrector for applying image correction processing to said face image.

6. An editing condition setting device as claimed in claim 5, wherein said image quality corrector applies said image correction processing to said face image in said still image after said face image is detected by said detector.

7. An editing condition setting device as claimed in claim 5, wherein said image quality corrector applies said image correction processing to said entire still image before said face image is detected by said detector.

8. An editing condition setting device as claimed in claim 1, wherein said cutout area is set as a base point of an effect applied to said photo movie, said effect includes at least one of a zoom effect for enlarging or reducing said face image and a panning effect for scrolling a closed-up part of said still image.

9. An editing condition setting device as claimed in claim 1, wherein said cutout area determiner reduces the size of said cutout area entirely if said cutout area becomes to include an external area of said still image after said position of said cutout area is adjusted to ensure said predetermined margin.

10. An editing condition setting program for making a computer execute an editing condition setting processing of a photo movie formed by applying processing and editing to a still image, for setting a cutout area including a face image of a subject as editing condition of said photo movie when said face image is cut out from said still image, as functions run by said computer, said editing condition setting program comprising:
a detecting function for detecting said face image in said still image; and
a cutout area determining function for optimizing and determining a position and size of said cutout area so as to ensure a predetermined margin between an outline of said cutout area and said face image based on a position and size of said face image detected by said detecting function.

11. An editing condition setting program as claimed in claim 10, further comprising: a target area designating function for displaying said still image on a display screen and for enabling to designate a position of said face image to be cut out in said still image as a target area through said display screen wherein said detector detects said face image within said target area, said detecting function detects said face image within said target area.

12. An editing condition setting program as claimed in claim 11, wherein said target area designating function enables to designate at least one point in said still image to define an area with a predetermined size centered on said point as said target area, said cutout area determining function determines said cutout area based on said target area.

13. An editing condition setting program as claimed in claim 10, wherein said detecting function detects said face image within the entire still image.

14. An editing condition setting program as claimed in claim 10, further comprising: an image quality correcting function for applying image correction processing to said face image.

15. An editing condition setting program as claimed in claim 14, wherein said image quality correcting function applies said image correction processing to said face image after said face image is detected by said detecting function.

16. An editing condition setting program as claimed in claim 14, wherein said image quality correcting function applies said image correction processing to said entire still image before said face image is detected by said detecting function.

17. An editing condition setting program as claimed in claim 10, wherein said cutout area is set as a base point of a special effect applied to said still image, said special effect includes at least one of a zoom effect for enlarging or reducing said face image and a panning effect for scrolling a closed-up part of said still image.

18. An editing condition setting program as claimed in claim 10, wherein said cutout area determining function reduces the size of said cutout area entirely if said cutout area becomes to include an external area of said still image after said position of said cutout area is adjusted to ensure said predetermined margin.

19. An editing condition setting device for a photo movie formed by applying processing and editing to a still image for setting a cutout area as an editing condition of said photo movie in order to apply a panning effect for scrolling a part of said still image to said photo movie, said cutout area including an object to be cut out from said still image and at least a start point and an end point of scrolling, said editing condition setting device comprising:
a target area designator for displaying said still image on a display screen for enabling to designate a position of said cutout object in said still image as a target area through said display screen, and displaying said target area on said display screen;
a detector for detecting a face image of a subject in said target area; and
a cutout area determiner for optimizing and determining a position and size of said cutout area so as to ensure a predetermined margin between an outline of said cutout area and said face image based on a position and size of said face image when said face image is detected by said detector, and for determining said target area as said cutout area when said face image is not detected by said detector.

20. An editing condition setting device as claimed in claim 19, wherein said target area designator enables to designate at least one arbitrary point in said still image to define an area with a predetermined size centered on said point, said cutout area determiner determines said cutout area based on said target area.

21. An editing condition setting device as claimed in claim 19, further comprising: a manual determiner for determining said cutout area manually.

22. An editing condition setting device as claimed in claim 21, wherein a minimum size of said cutout area is determined in accordance with a pixel number.

23. An editing condition setting device as claimed in claim 19, further comprising: an image quality corrector for applying image correction processing to said face image.

24. An editing condition setting device as claimed in claim 23, wherein said image quality corrector applies said image correction processing to said face image in said still image after said face image is detected by said detector.

25. An editing condition setting device as claimed in claim 23, wherein said image quality corrector applies said image correction processing to the entire still image before said face image is detected by said detector.

26. An editing condition setting program for making a computer execute setting processing of editing condition of a photo movie formed by applying processing and editing to a still image for setting a cutout area as an editing condition of said photo movie in order to apply a panning effect for scrolling a part of said still image to said photo movie, said cutout area including an object to be cut out from said still image and at least a start point and an end point of scrolling, said editing condition setting program comprising:
a target area designating function for displaying said still image on a display screen and for enabling to designate a position of said cutout object in said still image as a target area through said display screen;
a detecting function for detecting a face image of a subject in said target area; and
a cutout area determining function for optimizing and determining a position and size of said cutout area so as to ensure a predetermined margin between an outline of said cutout area and said face image based on a position and size of said face image when said face image is detected by a detecting function, and for determining said target area as said cutout area when said face image is not detected by a detecting function.

27. An editing condition setting program as claimed in claim 26, wherein said target area designating function enables to designate at least one arbitrary point in said still image to define an area with a predetermined size centered on said point, said cutout area determining function determines said cutout area based on said target area.

28. An editing condition setting program as claimed in claim 26, further comprising: a manual determining function for determining said cutout area manually.

29. An editing condition setting program as claimed in claim 28, wherein a minimum size of said cutout area is determined in accordance with a pixel number.

30. An editing condition setting program as claimed in claim 26, further comprising: an image quality correcting function for applying image correction processing to said face image.

31. An editing condition setting program as claimed in claim 30, wherein said image quality correcting function applies image correction processing to said face image in said still image after said face image is detected by said detecting function.

32. An editing condition setting program as claimed in claim 30, wherein said image quality correcting function applies image correction processing to the entire still image before said face image is detected by said detecting function.
